(19) United States
(12) Patent Application Publication
(10) Pub. No.: US 2023/0224415 A1
(43) Pub. Date: Jul. 13, 2023

(54) INFORMATION PROCESSING APPARATUS AND METHOD AND NON-TRANSITORY COMPUTER READABLE MEDIUM

(71) Applicant: FUJIFILM Business Innovation Corp., Tokyo (JP)

(72) Inventor: Satoshi HANAMURA, Kanagawa (JP)

(73) Assignee: FUJIFILM Business Innovation Corp., Tokyo (JP)

(21) Appl. No.: 17/873,759

(22) Filed: Jul. 26, 2022

(30) Foreign Application Priority Data
Jan. 11, 2022 (JP) 2022-002454

(51) Int. Cl. H04N 1/00

(52) U.S. Cl. CPC H04N 1/00429; H04N 1/00427

(57) ABSTRACT

An information processing apparatus includes a processor configured to: obtain an operation history including content of transition of screens and content of changing of settings; and generate an operation tree having a tree structure by using the obtained operation history and hierarchy position information indicating a position of a hierarchical level which is preset for each screen, the operation tree representing the content of the transition of screens and the content of the changing of settings.

### CROSS-REFERENCE TO RELATED APPLICATIONS

This application is based on and claims priority under 35 USC 119 from Japanese Patent Application No. 2022-002454 filed Jan. 11, 2022.

### BACKGROUND

### (I) Technical Field

The present disclosure relates to an information processing apparatus and method and a non-transitory computer readable medium.

### (II) Related Art

Japanese Unexamined Patent Application Publication No. 2010-187213 discloses an image forming apparatus including a recorder, a display, and a setting change reflector. The recorder records, as setting operation history information, a history of a setting operation performed by a user on an operation panel. The display reproduces and displays a past setting operation screen on the operation panel, based on the recorded setting operation history information. The setting change reflector reflects, in existing setting information, setting information which is changed on the displayed past setting operation screen on the operation panel. A job is executed in accordance with the changed setting information.

Japanese Unexamined Patent Application Publication No. 2010-086146 discloses an input display device including a used selection key determiner, a storage processor, and a used selection key history display controller. A liquid crystal display (LCD) panel has a basic setting screen and an operation history screen. On the basic setting screen, operation keys are displayed and arranged at fixed positions in each hierarchical level. On the operation history screen, an operation history indicating that an operation key is selected is displayed. When an operation key is selected on the basic setting screen or the operation history screen, the used selection key determiner determines which operation key is selected. The storage processor sequentially stores determination results obtained by the used selection key determiner in a volatile memory as operation history information. The used selection key history display controller displays the operation history information stored in the volatile memory on the operation history screen.

Japanese Unexamined Patent Application Publication No. 2011-051163 discloses an image forming apparatus including a screen flow creating information obtainer, a screen flow creator, a display screen customizer, and a screen flow creating information modifier. The screen flow creating information obtainer obtains screen flow creating information including screen information, setting operation information indicating a setting state implemented by a key operation on a display screen, and screen order information indicating the screen transition order of the display screen. Based on the screen flow creating information, the screen flow creator creates a screen image representing the setting state implemented by the key operation on the display screen and creates a screen flow in which screen images are arranged in the screen transition order. The display screen customizer changes the screen information and customizes the display screen. The screen flow creating information modifier modifies the obtained screen flow creating information based on the changed screen information. The screen flow creator creates a screen flow based on the modified screen flow creating information.

### SUMMARY

In the related art, a technology for creating an operation procedure as a flow diagram by linking a screen transition history and a setting change history with each other and by drawing a series of operations in one way is available. In this technology, if a series of operations is complicated, such as shifting from one hierarchical level to another and then shifting back to the previous hierarchical level, the same screen appears multiple times, and the resulting flow diagram becomes complicated and is not easy to understand. In this manner, in a flow diagram in which an operation procedure is drawn in one way, it is difficult to identify the hierarchical levels which are not arranged in order, thereby making it difficult to understand the operation procedure.

Aspects of non-limiting embodiments of the present disclosure relate to providing of an information processing apparatus and method and a non-transitory computer readable medium which make it possible to present an operation procedure that is visually easier to understand than when a one-way flow diagram is created by drawing a procedure of operations in one way.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: obtain an operation history including content of transition of screens and content of changing of settings; and generate an operation tree having a tree structure by using the obtained operation history and hierarchy position information indicating a position of a hierarchical level which is preset for each screen, the operation tree representing the content of the transition of screens and the content of the changing of settings.

### BRIEF DESCRIPTION OF THE DRAWINGS

An exemplary embodiment of the present disclosure will be described in detail based on the following figures, wherein:

FIG. 1 is a schematic diagram illustrating an information processing system according to the exemplary embodiment;

FIG. 2 is a block diagram illustrating major parts of an electrical system of an image forming apparatus in the information processing system according to the exemplary embodiment;

FIG. 3 is a block diagram illustrating major parts of an electrical system of a client computer and a server in the information processing system according to the exemplary embodiment;

FIG. 4 is a block diagram of the functional configuration of a control unit of the image forming apparatus according to the exemplary embodiment;

FIG. 5 illustrates an example of a transition order list;

FIG. 6 illustrates an example of a setting change order list;

FIG. 7 illustrates an example of screen position information;

FIG. 8 illustrates an example of an operation tree;

FIG. 9 is a flowchart illustrating an example of processing executed by an operation tree generator of the image forming apparatus according to the exemplary embodiment;

FIG. 10 is a flowchart illustrating an example of drawing processing for setting changes;

FIG. 11 is a flowchart illustrating an example of processing executed by an operation history storage; and

FIG. 12 illustrates an example of a one-way flow diagram.

### DETAILED DESCRIPTION

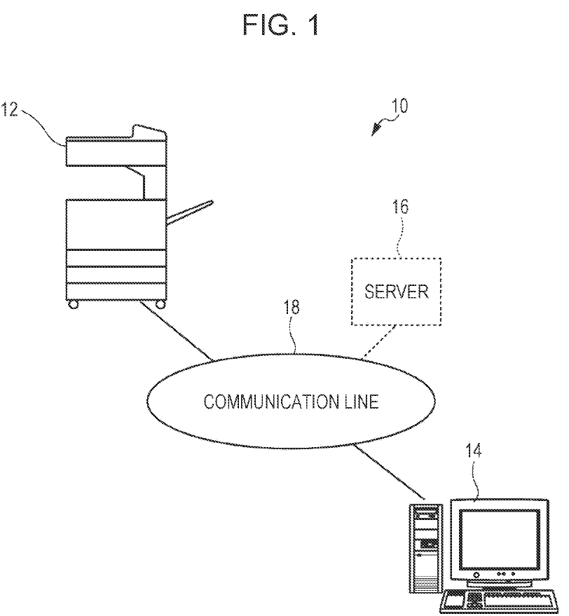

An example of the exemplary embodiment will be described below in detail with reference to the accompanying drawings. In the exemplary embodiment, an information processing system in which an image forming apparatus, which serves as an information processing apparatus, and a client computer are connected to each other via a communication line will be discussed below by way of example. As the communication line, various networks may be used. FIG. 1 is a schematic diagram illustrating an information processing system 10 according to the exemplary embodiment.

As shown in FIG. 1, the information processing system 10 includes an image forming apparatus 12 and a client computer 14. The image forming apparatus 12 and the client computer 14 are connected to each other via a communication line 18, such as a local area network (LAN), a wide area network (WAN), the internet, and an intranet. The image forming apparatus 12 and the client computer 14 can send and receive various types of data to and from each other via the communication line 18. In the exemplary embodiment, the client computer 14 can remotely operate the image forming apparatus 12. For example, to explain an operation procedure of the image forming apparatus 12, a customer engineer remotely operates the image forming apparatus 12. Although one image forming apparatus 12 and one client computer 14 are shown in FIG. 1, plural image forming apparatuses 12 and/or plural client computers 14 may be provided. In the exemplary embodiment, the client computer 14 remotely operates the image forming apparatus 12 via the communication line 18 by way of example. Alternatively, a client terminal, such as a mobile terminal or a laptop personal computer, can directly operate the image forming apparatus 12 via short-range wireless communication, such as Wi-Fi (registered trademark) and Bluetooth (registered trademark). The information processing system 10 may also include a server 16, as indicated by the dotted lines in FIG. 1, and the client computer 14 may operate the image forming apparatus 12 via the server 16.

The image forming apparatus 12 has multiple functions, such as an image forming function of performing image forming processing based on data received via the communication line 18, a read function of reading a document and generating image information indicating the read document, a copy function of copying an image recorded on a document onto a sheet, a fax function of sending and receiving various types of data via a telephone line (not shown), a transfer function of transferring document information, such as image information, generated as a result of a function such as the read function reading a document, and a store function of storing document information, such as image information, generated as a result of a function such as the read function reading a document.

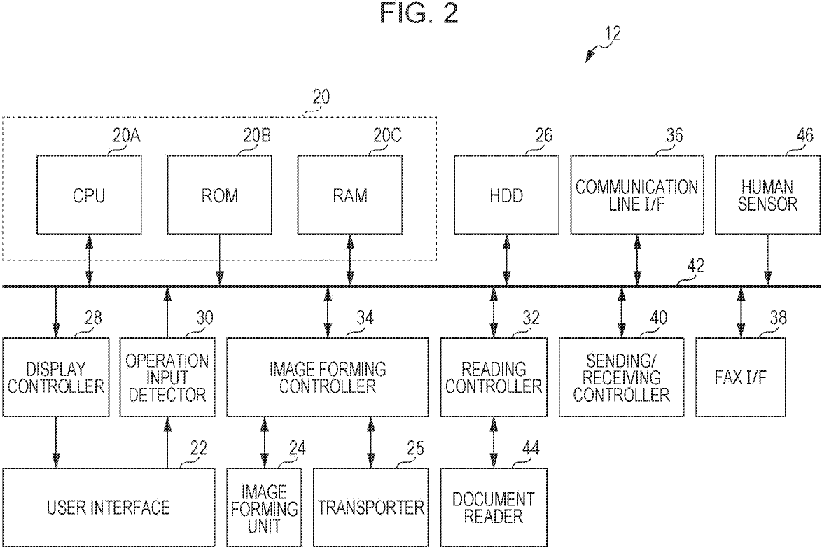

FIG. 2 is a block diagram illustrating major parts of the electrical system of the image forming apparatus 12 in the information processing system 10 according to the exemplary embodiment.

As shown in FIG. 2, the image forming apparatus 12 includes a control unit 20 having a central processing unit (CPU) 20A, a read only memory (ROM) 20B, and a random access memory (RAM) 20C. The CPU 20A, which is an example of a processor, controls the entire operation of the image forming apparatus 12. The RAM 20C is used as a work area, for example, for the CPU 20A to execute various programs. In the ROM 20B, various control programs and various parameters, for example, are stored in advance. In the image forming apparatus 12, the CPU 20A, the ROM 20B, and the RAM 20C of the control unit 20 are electrically connected to each other via a system bus 42.

The image forming apparatus 12 includes a hard disk drive (HDD) 26, a display controller 28, and an operation input detector 30. The HDD 26 stores various types of data and application programs. The display controller 28 is connected to a user interface 22 to control the displaying of various screens, such as operation screens, on a display of the user interface 22. The operation input detector 30 is also connected to the user interface 22 to detect an operation instruction input via the user interface 22. In the image forming apparatus 12, the HDD 26, the display controller 28, and the operation input detector 30 are electrically connected to the system bus 42. Although the HDD 26 is used as a storage device in the exemplary embodiment, another non-volatile storage, such as a flash memory, may alternatively be used as the storage device.

The image forming apparatus 12 also includes a reading controller 32 and an image forming controller 34. The reading controller 32 controls an optical image-reading operation performed by a document reader 44 and a document feeding operation performed by a document feeder. The image forming controller 34 controls image forming processing executed by an image forming unit 24 and the transporting operation of a sheet to the image forming unit 24 performed by a transporter 25. The image forming apparatus 12 also includes a communication line interface (communication line I/F) 36, a fax interface (fax I/F) 38, a sending/receiving controller 40, and a human sensor 46. The communication line I/F 36 is connected to the communication line 18 and sends and receives communication data to and from external devices, such as the client computer 14, connected to the communication line 18. The fax I/F 38 is connected to a telephone line (not shown) and sends and receives fax data to and from a fax device connected to the telephone line. The sending/receiving controller 40 controls sending/receiving of fax data performed via the fax I/F 38. The human sensor 46 detects people around the image forming apparatus 12. In the image forming apparatus 12, the sending/receiving controller 40, reading controller 32, image forming controller 34, communication line I/F 36, fax I/F 38, and human sensor 46 are electrically connected to the system bus 42. Although one human sensor 46 is shown in FIG. 2, plural human sensors 46 may be provided.

With the above-described configuration, by using the CPU 20A, the image forming apparatus 12 makes access to each of the RAM 20C, the ROM 20B, and the HDD 26. By using the CPU 20A, the image forming apparatus 12 performs the following various control operations by way of example: displaying of operation screens and information, such as various messages, on the display of the user interface 22 via the display controller 28; activation of the document reader 44 and the document feeder via the reading controller 32; activation of the image forming unit 24 and the transporter 25 via the image forming controller 34; sending/receiving of communication data via the communication line I/F 36; and sending/receiving of fax data via the fax I/F 38 under the control of the sending/receiving controller 40. By using the CPU 20A, the image forming apparatus 12 also identifies the content of operation performed on the user interface 22, based on operation information detected by the operation input detector 30, and then performs various control operations based on the identified content of operation.

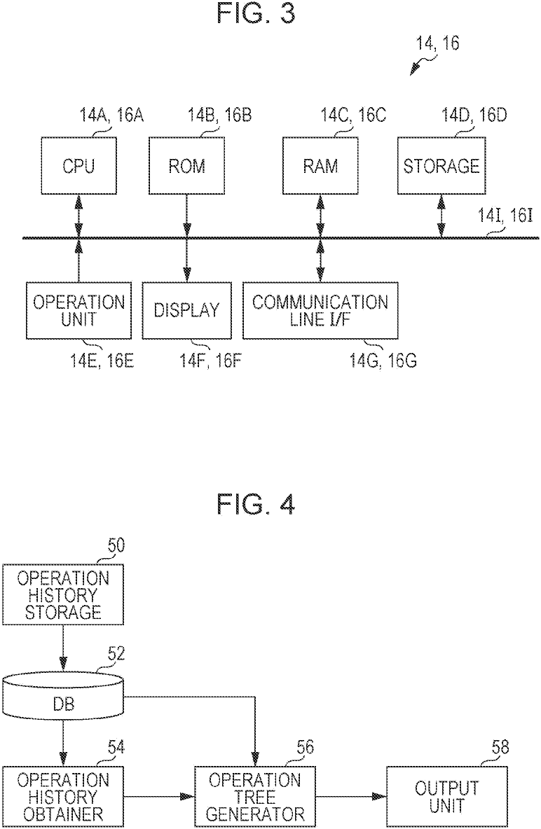

Major parts of the electrical system of the client computer 14 and those of the server 16 in the information processing system 10 according to the exemplary embodiment will be discussed below with reference to the block diagram of FIG. 3. Basically, the configuration of a typical computer is used for the client computer 14 and the server 16. An explanation will be given only of the configuration of the client computer 14 while omitting that of the server 16.

As shown in FIG. 3, the client computer 14 in the exemplary embodiment includes a CPU 14A, a ROM 14B, a RAM 14C, a storage 14D, an operation unit 14E, a display 14F, and a communication line interface (I/F) 14G. The CPU 14A controls the entire operation of the client computer 14. In the ROM 14B, various control programs and various parameters, for example, are stored in advance. The RAM 14C is used as a work area, for example, for the CPU 14A to execute various programs. In the storage 14D, various types of data and application programs, for example, are stored. The operation unit 14E is used for inputting various items of information. The display 14F is used for displaying various items of information. The communication line I/F 14G is connected to the communication line 18 and sends and receives various types of data to and from other devices connected to the communication line 18. The communication line I/F 14G may be able to directly communicate with other devices by using various known wireless communication systems. The above-described elements of the client computer 14 are electrically connected to each other via a system bus 14I. Although the storage 14D is used as a storage device in the exemplary embodiment, another non-volatile storage, such as an HDD or a flash memory, may alternatively be used as the storage device.

With the above-described configuration, by using the CPU 14A, the client computer 14 makes access to each of the ROM 14B, the RAM 14C, and the storage 14D. By using the CPU 14A, the client computer 14 also obtains various types of data via the operation unit 14E, displays various items of information on the display 14F, and performs control to send and receive communication data via the communication line I/F 14G.

The functional configuration of the control unit 20 of the image forming apparatus 12 will now be described below with reference to the block diagram of FIG. 4.

The image forming apparatus 12 according to the exemplary embodiment has a function of allowing the maintenance staff to remotely operate the image forming apparatus 12. For example, the maintenance staff can remotely operate the image forming apparatus 12 from the client computer 14 to explain how to operate the image forming apparatus 12 to a user. With this function, a customer engineer, for example, can explain an operation procedure to a user by remotely operating the image forming apparatus 12. In the image forming apparatus 12, the operation procedure is stored as an operation history so that a user can double-check the operation procedure or another user who is not given an explanation of the operation procedure can share the operation procedure. Then, the control unit 20 executes processing to create a flow diagram, which enables a user to check the operation procedure, by using the operation history and to display the created flow diagram. When executing this processing, to allow a user to easily check the operation procedure, the control unit 20 creates a flow diagram by using position information indicating the position of a hierarchical level which is preset for each screen so that a user can easily visually understand the overall structure.

More specifically, as a result of the CPU 20A executing a program stored in the ROM 20B, the control unit 20 implements functions such as an operation history storage 50, an operation history obtainer 54, an operation tree generator 56, an output unit 58. By using these functions, the control unit 20 executes processing to store an operation procedure as an operation history and to create a flow diagram for checking the operation procedure.

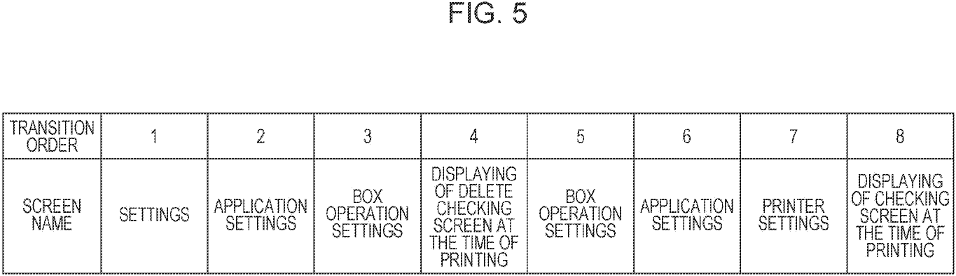

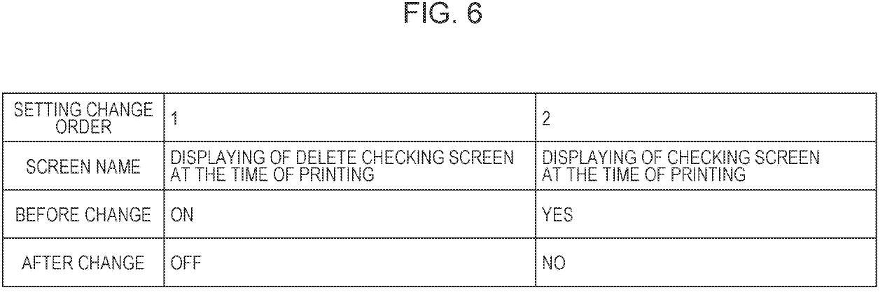

When the image forming apparatus 12 is remotely operated from the client computer 14, the operation history storage 50 stores an operation history including the content of the transition of screens and the content of changing of settings in the HDD 26 as a database (DB) 52. The operation history serves as the operation procedure. The operation history storage 50 may also store an operation history other than the history of the remote control operation in the HDD 26 as the DB 52. For example, the operation history storage 50 stores, in the DB 52, a transition order list in which the transition of screens is recorded in chronological order, such as that shown in FIG. 5, and a setting change order list in which the changing of settings is recorded in chronological order, such as that shown in FIG. 6. In the example of the transition order list in FIG. 5, the transition order of screens is in the following order: settings, application settings, box operation settings, displaying of a delete checking screen at the time of printing, box operation settings, application settings, printer settings, and displaying of a checking screen at the time of printing. In the example of the setting change order list in FIG. 6, displaying of the delete checking screen at the time of printing is changed from “ON” to “OFF”, and displaying of the checking screen at the time of printing is changed from “YES” to “NO”. In one example of the exemplary embodiment, the operation history storage 50 stores an operation history every time the screen is shifted.

When a user has selected an operation history by operating the user interface 22 to check the operation procedure, the operation history obtainer 54 obtains the selected operation history from the DB 52. For example, when a user has performed an operation for displaying operation histories, the operation history obtainer 54 displays a list of the operation histories stored in the DB 52 and obtains an operation history selected by the user from the list.

The operation tree generator 56 generates an operation tree having a tree structure, which represents the content of the transition of screens and the content of changing of settings, by using the operation histories obtained by the operation history obtainer 54 and position information indicating the position of a hierarchical level which is preset for each screen. The position information is prestored in the DB 52. A detailed approach to generating an operation tree will be discussed later.

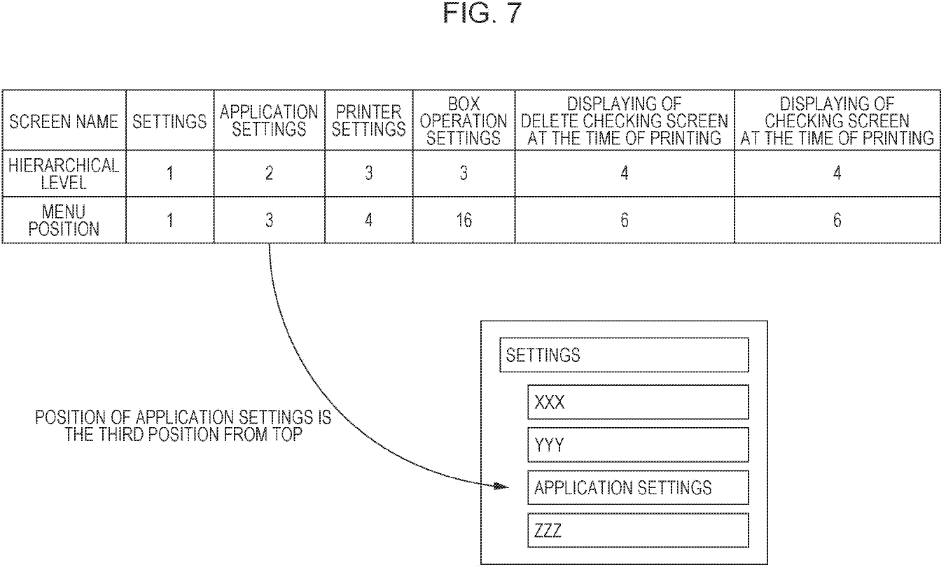

An example of position information indicating the position of a hierarchical level which is preset for each screen is shown in FIG. 7 as screen position information. In the screen position information shown in FIG. 7, the hierarchical level for each screen and the menu position of each screen are stored as screen position information. The menu position indicates the position of a screen on a menu screen. For instance, in the example in FIG. 7, regarding the application settings screen, the hierarchical level is two and the menu position is the third from the top of the settings screen.

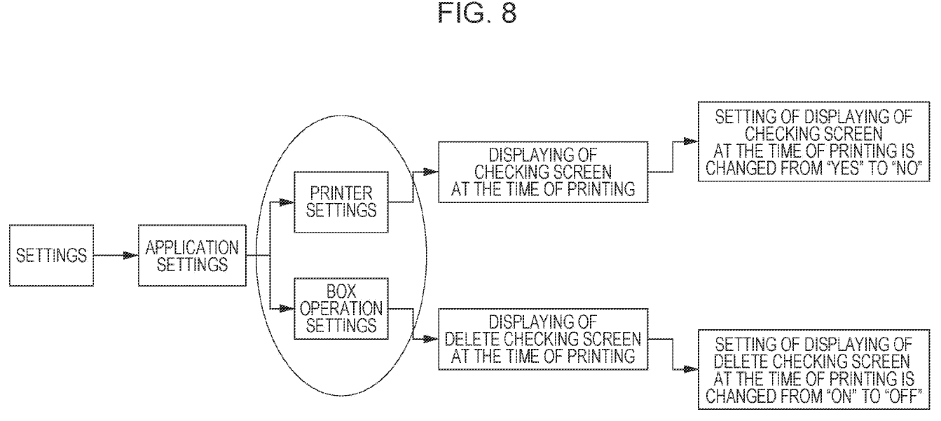

The operation tree generator 56 generates an operation tree, such as that shown in FIG. 8, by using the operation histories shown in FIGS. 5 and 6. The operation tree shown in FIG. 8 is an example of a horizontally extending operation tree. A vertically extending operation tree may alternatively be generated. A selection result regarding whether an operation tree is to be generated in the horizontal direction or in the vertical direction may be received, and an operation tree may be created in accordance with the selection result. Alternatively, whether an operation tree is to be generated in the horizontal direction or in the vertical direction may be set in advance, and the operation tree may be generated in accordance with the setting. Alternatively, whether an operation tree is to be generated in the horizontal direction or in the vertical direction may be determined in accordance with whether a screen or a region in a screen which displays an operation tree has a landscape orientation or a portrait orientation. The operation tree is a tree having a structure in which one item of data is divided into multiple portions in accordance with hierarchical levels and the divided portions are linked with lines while portions in the same hierarchical level are placed at the same level of the operation tree.

The output unit 58 outputs the operation tree generated by the operation tree generator 56. For example, the output unit 58 outputs the operation tree by displaying it on the display of the user interface 22. In response to a user instruction, the output unit 58 may output the operation tree by printing it as a report and/or by forming it into a document and sending the document to an external source.

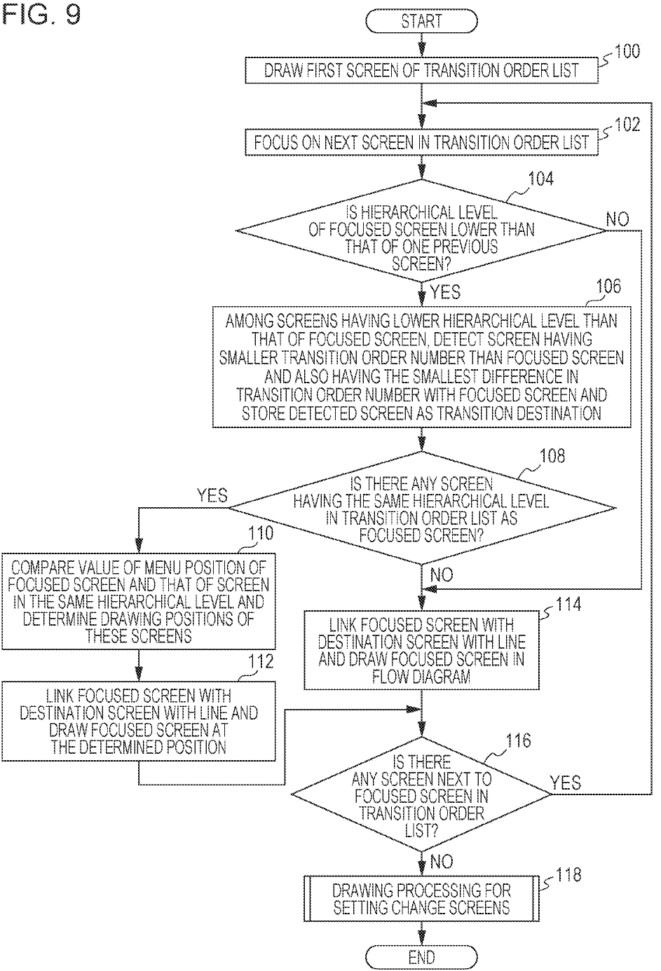

Specific processing to be executed by the image forming apparatus 12 in the above-configured information processing system 10 of the exemplary embodiment will now be described below. FIG. 9 is a flowchart illustrating an example of processing executed by the operation tree generator 56 of the image forming apparatus 12 according to the exemplary embodiment. The processing in FIG. 9 is started, for example, when a user has selected an operation history and has given an instruction to generate an operation tree by operating the user interface 22.

In step 100, the CPU 20A draws the screen indicated at the first position of the transition order list. That is, the CPU 20A draws the first screen of the transition order list stored in the DB 52. In the example of the transition order list shown in FIG. 5, the CPU 20A draws a settings screen. The CPU 20A then proceeds to step 102.

In step 102, the CPU 20A focuses on the next screen in the transition order list and proceeds to step 104.

In step 104, the CPU 20A judges whether the hierarchical level of the focused screen is lower than that of the one previous screen. If the result of step 104 is YES, the CPU 20A proceeds to step 106. If the result of step 104 is NO, the CPU 20A proceeds to step 114. For example, if the application settings screen at the sixth position of the transition order list in FIG. 5 is the focused screen, the hierarchical level of the application settings screen is lower than that of the one previous screen, that is, the box operation settings screen, and the CPU 20A thus proceeds to step 106.

In step 106, among the screens having a lower hierarchical level than that of the focused screen, the CPU 20A detects a screen having a smaller transition order number than the focused screen and also having the smallest difference in the transition order number with the focused screen. For example, if the focused screen is the application settings screen at the sixth position of the transition order list in FIG. 5, the CPU 20A determines the settings screen as the screen which satisfies the condition described in step 106 and then stores the settings screen as a transition destination. The CPU 20A then proceeds to step 108.

In step 108, the CPU 20A judges whether there is a screen having the same hierarchical level in the transition order list as the focused screen. If the result of step 108 is YES, the CPU 20A proceeds to step 110. If the result of step 108 is NO, the CPU 20A proceeds to step 114.

In step 110, the CPU 20A compares the value of the menu position of the current screen (focused screen) and that of the screen in the same hierarchical level as the current screen and determines the drawing positions of these screens. For example, the CPU 20A draws the screen having a smaller value of the menu position at a higher position so that the resulting structure can be closer to a menu hierarchical structure. For example, if the printer settings screen at the seventh position of the transition order list in FIG. 5 is the current screen (focused screen), the box operation settings screen has the same hierarchical level as the printer settings screen. The printer settings screen and the box operation settings screen are thus arranged vertically side by side, as indicated by the ellipse, as shown in FIG. 8. As shown in FIG. 7, the value of the menu position of the printer settings screen is smaller than that of the box operation settings screen. The printer settings screen is thus drawn at a higher position than the box operation settings screen. The resulting operation tree can thus become closer to a menu hierarchical structure.

In this example, a screen having a smaller value of the menu position is located at a higher position. Conversely, a screen having a greater value of the menu screen may be located at a higher position. Alternatively, without using the menu position information, the positions of screens having the same hierarchical level may be determined in ascending transition order of the screens and be located from the top or the bottom of the operation tree. Whether to use the menu position information may be selected and the drawing positions may be determined in accordance with the selection result. Whether to use the menu position information may be set in advance and the drawing positions may be determined in accordance with the setting.

In step 112, the CPU 20A links the focused screen with the destination screen stored in step 106 with a line and draws the focused screen at the position determined in step 110. The CPU 20A then proceeds to step 116.

In step 114, the CPU 20A links the focused screen with the destination screen stored in step 106 with a line and draws the focused screen in a flow diagram. The CPU 20A then proceeds to step 116.

In step 116, the CPU 20A judges whether there is a screen subsequent to the focused screen in the transition order list. If the result of step 116 is YES, the CPU 20A returns to step 102 and repeats the above-described processing. If the result of step 116 is NO, the CPU 20A proceeds to step 118.

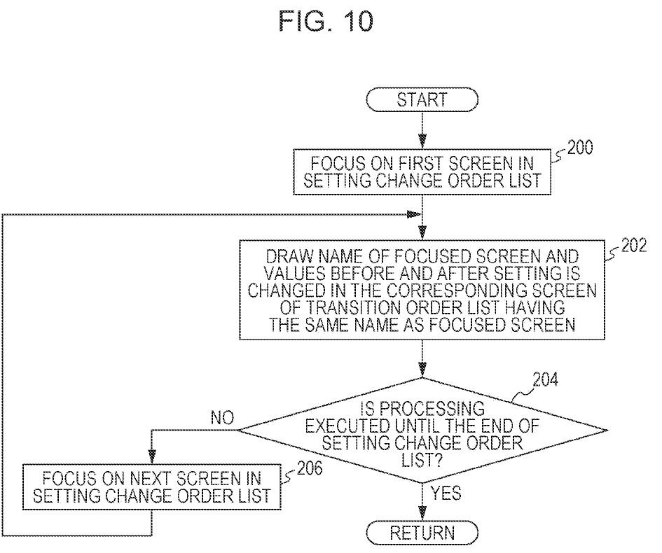

In step 118, the CPU 20A executes drawing processing for setting change screens and completes the processing. Drawing processing for setting change screens will be discussed below with reference to FIG. 10. FIG. 10 is a flowchart illustrating an example of drawing processing for setting change screens.

In step 200, the CPU 20A focuses on the first screen in the setting change order list and then proceeds to step 202.

In step 202, the CPU 20A draws the name of the focused setting change screen and the values before and after a setting is changed. In this case, the CPU 20A draws the above-described name of the screen and values in the corresponding screen of the transition order list having the same name as the focused screen. The CPU 20A then proceeds to step 204.

In step 204, the CPU 20A judges whether processing is executed until the end of the setting change order list. If the result of step 204 is NO, the CPU 20A proceeds to step 206. If the result of step 204 is YES, the CPU 20A completes the drawing processing for setting change screens and returns to the processing in FIG. 9.

In step 206, the CPU 20A focuses on the next screen in the setting change order list and returns to step 202 to repeat the above-described processing.

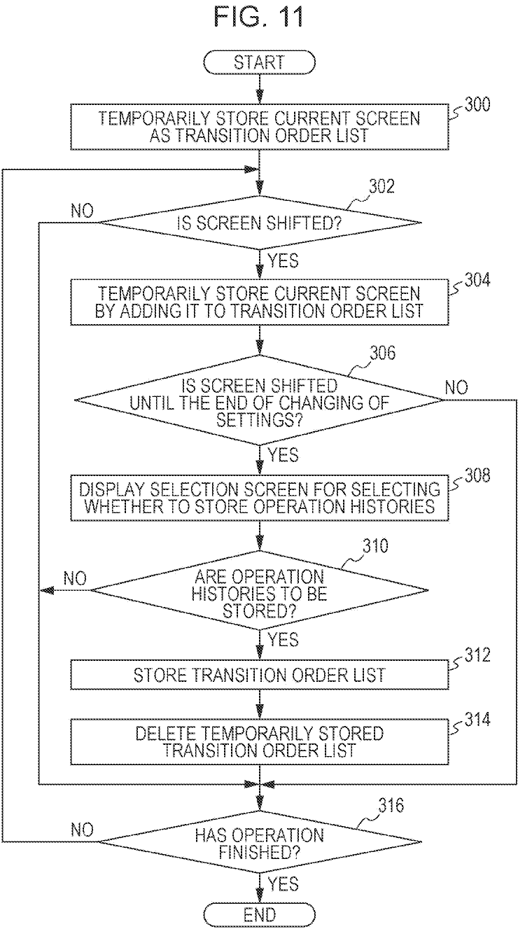

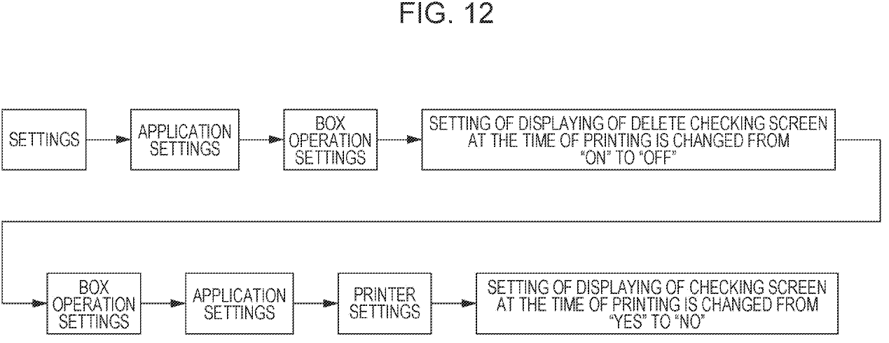

In the above-described exemplary embodiment, an operation history is stored every time the screen is shifted. However, a user may select whether to store the operation histories at a timing at which the screen is shifted until the end of the changing of settings. If the user has selected not to store the operation history of the same operation content, the space of the HDD 26 can be saved. In this case, the operation history storage 50 executes processing shown in FIG. 11. FIG. 11 is a flowchart illustrating an example of processing executed by the operation history storage 50.

In step 300, the CPU 20A temporarily stores the current screen in a storage, such as the RAM 20C, as a transition order list and then proceeds to step 302.

In step 302, the CPU 20A determines whether the screen is shifted. The CPU 20A makes this determination based on, for example, whether an operation for shifting the screen is performed. If the result of step 302 is YES, the CPU 20A proceeds to step 304. If the result of step 302 is NO, the CPU 20A proceeds to step 316.

In step 304, the CPU 20A temporarily stores the current screen in a storage, such as the RAM 20C, by adding the current screen to the transition order list. The CPU 20A then proceeds to step 306.

In step 306, the CPU 20A determines whether the screen is shifted until the end of the changing of settings. The CPU 20A makes this determination based on, for example, whether the screen is shifted to a setting change screen. If the result of step 306 is YES, the CPU 20A proceeds to step 308. If the result of step 306 is NO, the CPU 20A proceeds to step 316.

In step 308, the CPU 20A displays a selection screen for selecting whether to store the operation histories. For example, the CPU 20A displays a predetermined selection screen for instructing a user to select whether to store the operation procedure up to the current setting screen, and then receives a selection result from the user. The CPU 20A then proceeds to step 310.

In step 310, the CPU 20A judges whether the user has chosen to store the operation procedure up to the current setting screen. If the result of step 310 is YES, the CPU 20A proceeds to step 312. If the result of step 310 is NO, the CPU 20A proceeds to step 316.

In step 312, the CPU 20A stores the transition order list as the DB 52 and proceeds to step 314.

In step 314, the CPU 20A deletes the transition order list temporarily stored in the RAM 20C and proceeds to step 316.

In step 316, the CPU 20A determines whether the operation has finished. The CPU 20A makes this determination based on, for example, whether an operation for returning to a predetermined main screen is performed.

If the result of step 316 is NO, the CPU 20A returns to step 302 and repeats the above-described processing. If the result of step 316 is YES, the CPU 20A completes the processing in FIG. 11.

In the above-described exemplary embodiment, the operation procedure is displayed as an operation tree. However, the operation procedure may be displayed in another format, such as a one-way flow diagram shown in FIG. 12. In this case, a user may select whether to display an operation procedure as an operation tree or a one-way flow diagram. An operation tree and a one-way flow diagram may be displayed together.

In the exemplary embodiment, an explanation of the remote operation procedure has been discussed by way of example. However, the disclosure may be applicable to a case in which an operation procedure is explained by directly operating the image forming apparatus 12.

The above-described exemplary embodiment has been described, assuming that the image forming apparatus 12 is an example of the information processing apparatus. However, another apparatus, such as the client computer 14 or a mobile terminal, may be used as the information processing apparatus and may obtain operation histories from the image forming apparatus 12 and generate an operation tree.

Processing executed by the image forming apparatus 12 according to the above-described exemplary embodiment may be implemented by software, hardware, or a combination of software and hardware. Processing executed by the image forming apparatus 12 may be stored in a storage medium as a program and be distributed.

In the above-described exemplary embodiment, a CPU has been described as an example of a processor. However, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
obtain an operation history including content of transition of screens and content of changing of settings; and
generate an operation tree having a tree structure by using the obtained operation history and hierarchy position information indicating a position of a hierarchical level which is preset for each screen, the operation tree representing the content of the transition of screens and the content of the changing of settings.

2. The information processing apparatus according to claim 1, wherein the processor is configured to:
further obtain menu position information indicating positions of the screens to be displayed on a menu screen; and
generate the operation tree by using the menu position information, as well as the operation history and the hierarchy position information, so that the screens are located at the positions indicated by the menu position information.

3. The information processing apparatus according to claim 2, wherein the processor is configured to:
receive a selection result regarding whether to use the menu position information; and
generate the operation tree in accordance with the received selection result.

4. The information processing apparatus according to claim 1, wherein the processor is configured to generate the operation tree so that the operation tree extends in a horizontal direction or in a vertical direction.

5. The information processing apparatus according to claim 2, wherein the processor is configured to generate the operation tree so that the operation tree extends in a horizontal direction or in a vertical direction.

6. The information processing apparatus according to claim 3, wherein the processor is configured to generate the operation tree so that the operation tree extends in a horizontal direction or in a vertical direction.

7. The information processing apparatus according to claim 4, wherein the processor is configured to:
receive a selection result regarding whether the operation tree is to be generated in the horizontal direction or in the vertical direction; and
generate the operation tree in accordance with the received selection result.

8. The information processing apparatus according to claim 5, wherein the processor is configured to:
receive a selection result regarding whether the operation tree is to be generated in the horizontal direction or in the vertical direction; and
generate the operation tree in accordance with the received selection result.

9. The information processing apparatus according to claim 6, wherein the processor is configured to:
receive a selection result regarding whether the operation tree is to be generated in the horizontal direction or in the vertical direction; and
generate the operation tree in accordance with the received selection result.

10. The information processing apparatus according to claim 1, wherein the processor is configured to:
receive a selection result regarding whether to store the operation history when a screen is shifted until an end point of setting screens; and
store the operation history in accordance with the received selection result.

11. The information processing apparatus according to claim 2, wherein the processor is configured to:
receive a selection result regarding whether to store the operation history when a screen is shifted until an end point of setting screens; and
store the operation history in accordance with the received selection result.

12. The information processing apparatus according to claim 3, wherein the processor is configured to:
receive a selection result regarding whether to store the operation history when a screen is shifted until an end point of setting screens; and
store the operation history in accordance with the received selection result.

13. The information processing apparatus according to claim 4, wherein the processor is configured to:
receive a selection result regarding whether to store the operation history when a screen is shifted until an end point of setting screens; and
store the operation history in accordance with the received selection result.

14. The information processing apparatus according to claim 5, wherein the processor is configured to:
receive a selection result regarding whether to store the operation history when a screen is shifted until an end point of setting screens; and
store the operation history in accordance with the received selection result.

15. The information processing apparatus according to claim 6, wherein the processor is configured to:
receive a selection result regarding whether to store the operation history when a screen is shifted until an end point of setting screens; and
store the operation history in accordance with the received selection result.

16. The information processing apparatus according to claim 1, wherein the processor is configured to output the operation tree by performing at least one of processing for printing the operation tree as a report and processing for forming the operation tree into a document and sending the document to an external source.

17. The information processing apparatus according to claim 1, wherein the processor is configured to:
generate, by using the operation history, a flow diagram in which operations are arranged in one direction in a screen transition order; and
output at least one of the generated operation tree and the generated flow diagram.

18. The information processing apparatus according to claim 17, wherein the processor is configured to:
receive a selection result regarding whether to output the generated operation tree and/or the generated flow diagram; and
output the generated operation tree and/or the generated flow diagram in accordance with the received selection result.

19. A non-transitory computer readable medium storing a program causing a computer to execute a process, the process comprising:
obtaining an operation history including content of transition of screens and content of changing of settings; and
generating an operation tree having a tree structure by using the obtained operation history and hierarchy position information indicating a position of a hierarchical level which is preset for each screen, the operation tree representing the content of the transition of screens and the content of the changing of settings.

20. An information processing method comprising:
obtaining an operation history including content of transition of screens and content of changing of settings; and
generating an operation tree having a tree structure by using the obtained operation history and hierarchy position information indicating a position of a hierarchical level which is preset for each screen, the operation tree representing the content of the transition of screens and the content of the changing of settings.
